(19) United States
(12) Patent Application Publication
(10) Pub. No.: US 2022/0255103 A1
(43) Pub. Date: Aug. 11, 2022

(54) Anti-passivation, anti-blockage and efficiency-enhancing ultrasonic fuel cell

(71) Applicant: Zhijun PENG, Foshan (CN)

(72) Inventor: Zhijun PENG, Foshan (CN)

(21) Appl. No.: 17/572,588

(22) Filed: Jan. 10, 2022

(30) Foreign Application Priority Data
Feb. 5, 2021 (CN) 202110162581.9

(51) Int. Cl. H01M 8/0662; H01M 8/04082; H01M 8/0273; H01M 8/0276; H01M 8/0258; B08B 7/02; B08B 9/027

(52) U.S. Cl. CPC H01M 8/0662; H01M 8/04201; H01M 8/0273; H01M 2008/1095; H01M 8/0258; B08B 7/028; B08B 9/027; H01M 8/0276

(57) ABSTRACT

An anti-passivation, anti-blockage and efficiency-enhancing ultrasonic fuel cell, which includes a front end plate, a rear end plate, electrode plates arranged between the front end plate and the rear end plate, a reaction membrane clamped between every two adjacent electrode plates, and screw nut assemblies fixing the front end plate, the electrode plates and the rear end plate together to form a galvanic pile; a reaction membrane is clamped in each membrane frame, and ultrasonic elements are arranged in the membrane frame. A concave ring slot is provided on each of two sides of each electrode plate to embed the membrane frame. The reaction membrane is clamped between every two adjacent electrode plates by being embedded in a respective concave ring slot via a respective membrane frame.

### BACKGROUND OF THE INVENTION

The present invention relates to fuel cell products and more particularly pertains to an ultrasonic fuel cell.

Fuel cell, also known as electrochemical generator, is a chemical device which converts chemical energy in fuels to electrical energy. Like hydro power, thermos power and nuclear power, fuel cell is one of the modern technologies for electricity generation. It is highly efficient as it converts the Gibbs free energy in the chemical energy of the fuel into electrical energy via electrochemical reaction without being limited by the Carnot cycle. Fuel cell uses fuel and oxygen as the basic components which minimize, if not eliminate, the emission of harmful gases. The absence of motor transmission parts also prevents noise production. Therefore, from the perspectives of energy conservation and environmental protection, fuel cell is considered to be an electricity generation technology with a promising development prospect.

Fuel cell is widely applied in aerospace, marine, automotive, household power supplies, and charging equipment, etc. However, during usage, the fluid channels on the bipolar plates, as well as the carbon paper/carbon cloths, catalyst sheet layers, and proton exchange membrane, etc., attached to the channels, are blocked and gradually passivated due to deposition of impurities during fuel reactions. This undermines the efficiency of the conversion into electrical energy or even causes malfunctioning. Therefore, it is important to solve the problem of deposition of impurities during fuel reactions to extend the usage life of fuel cells.

In view of the above, the applicant has submitted a patent application in China on 13 Dec. 2018 for the technical solution named “An ultrasound fuel cell” (Application no. 201811528683.2; publication no. CN109671961A). The technical solution comprises a front end plate, a rear end plate, a stack formed by stacking and combining a plurality of single cells connected in series, and screws, wherein the stack is arranged between the front end plate and the rear end plate and is fastened by the screws. Each single cell is formed by sequentially stacking a bipolar plate, a carbon paper/carbon cloth, a catalyst sheet layer, a proton exchange membrane, a second catalyst sheet layer, a second carbon paper/carbon cloth and another bipolar plate. A plurality of ultrasonic energy convertors are also arranged on the outer side of each single battery on the back surface of the bipolar plate, and the ultrasonic energy convertors are connected via electric wires. The high-frequency ultrasonic vibration generated by the ultrasonic energy convertors prevents the blockage by impurities generated during fuel reactions being deposited on the fluid channels, carbon paper/carbon cloths, catalyst sheet layers, proton exchange membrane and the like. This significantly delays the passivation of the fuel cell, improves the electric energy conversion efficiency of the fuel cell and extends the usage life and the reliability of the fuel cell. However, since the ultrasonic energy convertors are provided on the polar plates, the ultrasonic energy is only applied indirectly to the proton exchange membrane, the carbon paper/carbon cloths, and the catalyst sheet layers, leading to energy loss. Therefore, the applicant believes that the application of ultrasonic energy in fuel cells can be further optimized for a better performance of the fuel cell.

### BRIEF SUMMARY OF THE INVENTION

In view of the aforesaid disadvantages now present in the prior art, the present invention provides an anti-passivation, anti-blockage and efficiency-enhancing ultrasonic fuel cell, characterized in that each reaction membrane is mounted on a respective membrane frame, and ultrasonic elements are installed in the membrane frame to allow the ultrasonic elements to directly act on the reaction membrane. This allows the reaction membrane to receive a better and more direct effect from the ultrasonic energy and also reduces the loss of ultrasonic energy. The design of the membrane frame provides the reaction membrane with a larger volume for grabbing, which is more convenient for assembling and production by robots. This improves the production efficiency of the fuel cell while reducing its manufacturing cost, so that fuel cell can be quickly promoted and used in the market.

To attain this, the technical solution of the present invention adopts the following scheme:

An anti-passivation, anti-blockage and efficiency-enhancing ultrasonic fuel cell, comprising a front end plate, a rear end plate, a plurality of electrode plates arranged between the front end plate and the rear end plate, a reaction membrane clamped between every two adjacent electrode plates, and screw nut assemblies fixing the front end plate, the electrode plates and the rear end plate together to form a galvanic pile; characterized in further comprising membrane frames and ultrasonic elements; each reaction membrane is clamped in a respective membrane frame, and the ultrasonic elements are arranged in each membrane frame; a concave ring slot is provided on each of two sides of each electrode plate to embed a respective membrane frame on each side; the reaction membrane is clamped between every two adjacent electrode plates by being embedded in a respective concave ring slot via a respective membrane frame.

Preferably, a sealing gasket is further provided between each concave ring slot and a respective membrane frame.

Preferably, an inner cavity is further provided around each membrane frame, and the ultrasonic elements are installed in the inner cavity.

Preferably, an inner chamber is further disposed in a middle of each electrode plate, and the ultrasonic elements are provided in the inner chamber.

The benefits of the present invention are:

(1) Each reaction membrane is mounted to a respective membrane frame, and the ultrasonic elements are arranged in the membrane frame, so that the ultrasonic elements directly act on the reaction membrane. This allows the reaction membrane to receive a better and more direct effect from the ultrasonic energy and also reduces the loss of ultrasonic energy. The design of the membrane frame provides the reaction membrane with a larger volume for grabbing, which is more convenient for robotic assembly and production of the ultrasonic fuel cell. This improves the production efficiency of the fuel cell while reducing its manufacturing cost, so that fuel cell can be quickly promoted and used in the market.

(2) Under extremely cold environment, the present invention provides an ultrasonic heating effect on the galvanic pile. The ultrasonic vibration in high frequency causes internal molecules of the galvanic pile to vibrate rapidly and creates an ultrasonic cavitation effect. The mutual friction between molecules realizes the purpose of heating to prevent the galvanic pile, internal passageways and the membrane from freezing and blockage, ensuring normal flow of hydrogen and a normal operation as usual. This also prevents the fuel cell from malfunctioning or running with low energy conversion efficiency under extremely cold environment.

(3) The present invention utilizes the high-frequency ultrasonic vibration generated by the ultrasonic energy convertors to prevent the impurities generated during fuel reaction process from depositing on and blocking the fluid channels, the carbon paper/carbon cloths, the proton exchange membranes and the like. The impurities will flow out of the fuel cell along with the reacted substances, thereby greatly delaying the passivation and blockage of the fluid channels, the carbon paper/carbon cloths, the catalyst sheet layers, the proton exchange membranes and the like. This greatly improves the conversion efficiency of hydrogen to electricity, reduces the loss, improves energy conversion efficiency, and greatly prolongs the usage life and increases the reliability of the fuel cell.

### BRIEF DESCRIPTION OF THE DRAWINGS

FIG. 1 is a perspective structural view of the present invention.

FIG. 2 is an exploded view of the present invention.

FIG. 3 is a structural view of a reaction membrane and a membrane frame of the present invention.

FIG. 4 is a cross-sectional view of an electrode plate of the present invention.

### DETAILED DESCRIPTION OF THE INVENTION

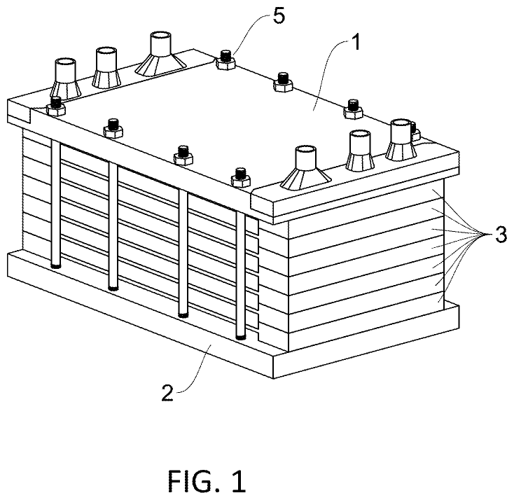

As illustrated in FIG. 1 to FIG. 4, an anti-passivation, anti-blockage and efficiency-enhancing ultrasonic fuel cell, comprises a front end plate 1, a rear end plate 2, a plurality of electrode plates 3 arranged between the front end plate 1 and the rear end plate 2, a reaction membrane 4 clamped between every two adjacent electrode plates 3, and screw nut assemblies 5 fixing the front end plate 1, the electrode plates 3 and the rear end plate 2 together to form a galvanic pile. The present invention also comprises membrane frames 6 and ultrasonic elements 7. Each reaction membrane 4 is clamped in a respective membrane frame 6, and the ultrasonic elements 7 are arranged in each membrane frame 6. A concave ring slot 31 is provided on each of two sides of each electrode plate 3 to embed a respective membrane frame 6 on each side. The reaction membrane 4 is clamped between every two adjacent electrode plates 3 by being embedded in a respective concave ring slot 31 via a respective membrane frame 6. In the present invention, each reaction membrane 4 is mounted to a respective membrane frame 6, and the ultrasonic elements 7 are arranged in the membrane frame 6, so that the ultrasonic elements 7 directly act on the reaction membrane 4. This allows the reaction membrane 4 to receive a better and more direct effect from the ultrasonic energy and also reduces the loss of ultrasonic energy. The sheet of reaction membrane 4 is too thin to be grabbed by robotic arm in the prior art, which makes it difficult to realize automatic manufacturing. In this present invention, the design of the membrane frame 6 provides the reaction membrane 4 with a larger volume for grabbing, which is more convenient for robotic assembly and production of the ultrasonic fuel cell. This improves the production efficiency of the fuel cell while reducing its manufacturing cost, so that fuel cell can be quickly promoted and used in the market.

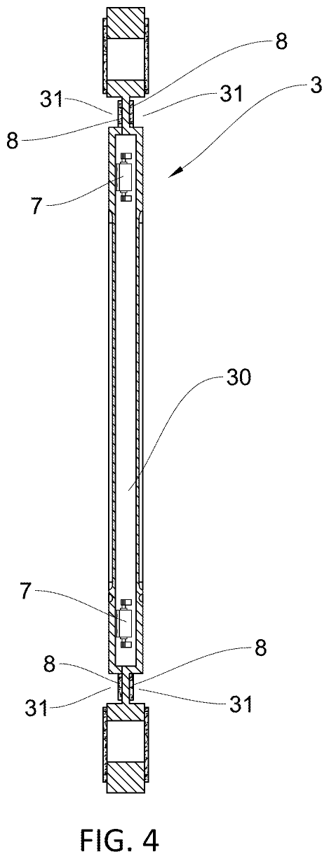

To ensure firm sealing of assembly of each membrane frame 6 and a respective electrode plate 3, as shown in FIG. 4, a sealing gasket 8 is further provided between each concave ring slot 31 and a respective membrane frame 6. The cooperative locking effect of the sealing gasket 8 and the screw nut assemblies 5 allows the membrane frame 6 to be simply and effectively sealed and assembled together with a respective electrode plate 3.

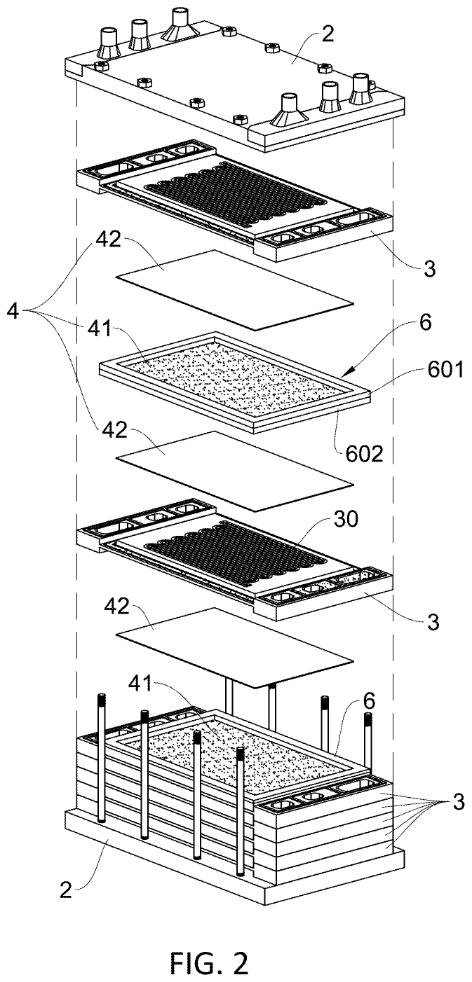

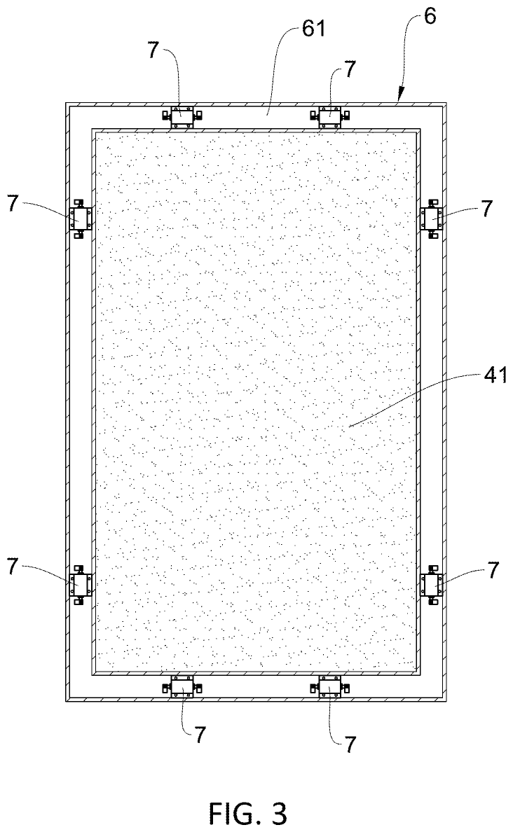

To allow the ultrasonic elements 7 to be easily installed in each membrane frame 6, as shown in FIG. 3, an inner cavity 61 is further provided around each membrane frame 6, and the ultrasonic elements 7 are installed in the inner cavity 61. As shown in FIG. 2, each membrane frame 6 comprises a frame lid 601, a bottom frame 602 and the inner cavity 61 formed in between. The reaction film 4 is clamped between the frame lid 601 and the bottom frame 602; the frame lid 601 and the bottom frame 602 are sealed together by an ultrasonic sealing machine.

The present invention also aims to enhance the overall cavitation effect of the ultrasonic energy on the fluid channels and the reaction membrane, so that the impurities generated during fuel reaction process will not deposit on the fluid channels or on the reaction membrane and hence prevents blockage. As shown in FIG. 4, an inner chamber 30 is further disposed in a middle of each electrode plate 3, and the ultrasonic elements 7 are also provided in the inner chamber 30.

As shown in FIG. 2, each reaction membrane 4 comprises a proton exchange membrane 41 and carbon cloths 42 covering two sides of the proton exchange membrane 41 respectively.

To optimize the effect of ultrasonic energy, the ultrasonic elements 7 are ultrasonic energy convertors of 1 MHz or above, or ultrasonic vibration motors of 10,000 RPM or above.

The above content presents the preferred embodiments of the present invention but does not limit the protection scope thereof. Changes and improvements made by a person skilled in this field of art in accordance with the scope of teachings of the present invention without deviating from the inventive concept of the present invention should also fall within the scope of protection of the present invention.

What is claimed is:

1. An ultrasonic fuel cell, comprising a front end plate, a rear end plate, a plurality of electrode plates arranged between the front end plate and the rear end plate, a reaction membrane clamped between every two adjacent electrode plates, and screw nut assemblies fixing the front end plate, the electrode plates and the rear end plate together to form a galvanic pile; characterized in further comprising membrane frames and ultrasonic elements; each reaction membrane is clamped in a respective membrane frame, and the ultrasonic elements are arranged in each membrane frame; a concave ring slot is provided on each of two sides of each electrode plate to embed a respective membrane frame on each side; the reaction membrane is clamped between every two adjacent electrode plates by being embedded in a respective concave ring slot via a respective membrane frame.

2. The ultrasonic fuel cell of claim 1, wherein a sealing gasket is further provided between each concave ring slot and a respective membrane frame.

3. The ultrasonic fuel cell of claim 1, wherein an inner cavity is further provided around each membrane frame, and the ultrasonic elements are installed in the inner cavity.

4. The ultrasonic fuel cell of claim 1, wherein an inner chamber is further disposed in a middle of each electrode plate, and the ultrasonic elements are provided in the inner chamber.

5. The ultrasonic fuel cell of claim 1, wherein each reaction membrane comprises a proton exchange membrane and carbon cloths covering two sides of the proton exchange membrane respectively.

6. The ultrasonic fuel cell of claim 1, wherein the ultrasonic elements are ultrasonic energy convertors of 1 MHz or above.

7. The ultrasonic fuel cell of claim 1, wherein the ultrasonic elements are ultrasonic vibration motors of 10,000 RPM or above.
